(19) United States
(12) Patent Application Publication
(10) Pub. No.: US 2012/0010896 A1
(43) Pub. Date: Jan. 12, 2012

(54) METHODS AND APPARATUS TO CLASSIFY REPORTS

(75) Inventors: Vijaykalyan Yeluri, Campbell, CA (US); Perry Frederick, Palo Alto, CA (US); Sandip Biswal, Stanford, CA (US)

(73) Assignee: GENERAL ELECTRIC COMPANY, Schenectady, NY (US)

(21) Appl. No.: 12/833,746

(22) Filed: Jul. 9, 2010

(51) Int. Cl. G06Q 10/00; G06F 17/30; G06Q 50/00

(52) U.S. Cl. 705/2; 707/737; 707/E17.046

(57) ABSTRACT

Methods and apparatus to classify reports are disclosed herein. An example method includes determining a type of an examination associated with a report; obtaining an identification of a person associated with the report; using the identification to determine whether the person associated with the report is specialized in the type of the examination; when the person associated with the report is specialized in the type of the examination, classifying the report as associated with a specialist; when the person associated with the report is unspecialized in the type of the examination, classifying the report as associated with a non-specialist; and presenting a document consumer with an indication of the classification of the report.

### FIELD OF THE DISCLOSURE

The present disclosure relates generally to reports and, more particularly, to methods and apparatus to classify reports.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during an ongoing medical procedure.

Medical practitioners, such as doctors, surgeons, and other medical professionals, rely on the clinical information stored in such systems to assess the condition of a patient, to provide immediate treatment to a patient in an emergency situation, to diagnose a patient, and/or to provide any other medical treatment or attention. In many instances, the clinical information includes voluminous patient medical histories containing detailed accounts of a plurality of medical events, treatments, modalities, diagnosis, prescriptions, etc. Parsing through the medical histories is time consuming and can be inefficient.

### SUMMARY

An example method to classify a report includes determining a type of an examination associated with a report. Further, the example method includes obtaining an identification of a person associated with the report. Further, the example method includes using the identification to determine whether the person associated with the report is specialized in the type of the examination. Further, the example method includes, when the person associated with the report is specialized in the type of the examination, classifying the report as associated with a specialist. Further, the example method includes, when the person associated with the report is unspecialized in the type of the examination, classifying the report as associated with a non-specialist. Further, the example method includes presenting a document consumer with an indication of the classification of the report.

An example tangible machine readable medium has instructions stored thereon that, when executed, cause a machine to determine a type of an examination associated with a report. Further, the example tangible machine readable medium has instructions stored thereon that, when executed, cause a machine to obtain an identification of a person associated with the report. Further, the example tangible machine readable medium has instructions stored thereon that, when executed, cause a machine to use the identification to determine whether the person associated with the report is specialized in the type of the examination. Further, the example tangible machine readable medium has instructions stored thereon that, when executed, cause a machine to, when the person associated with the report is specialized in the type of the examination, classify the report as associated with a specialist. Further, the example tangible machine readable medium has instructions stored thereon that, when executed, cause a machine to, when the person associated with the report is unspecialized in the type of the examination, classify the report as associated with a non-specialist. Further, the example tangible machine readable medium has instructions stored thereon that, when executed, cause a machine to present a document consumer with an indication of the classification of the report.

An example apparatus to classify a report includes an examination type identifier to determine a type of an examination associated with a report. Further, the example apparatus includes a person identifier to obtain an identification of a person associated with the report. Further, the example apparatus includes a specialty retriever to obtain one or more specialties associated with the person using the identification. Further, the example apparatus includes a comparator to determine whether the person associated with the report is specialized in the type of the examination. Further, the example apparatus includes a classification assignor to, when the person associated with the report is specialized in the type of the examination, classify the report as associated with a specialist. Further, the example classification assignor is to, when the person associated with the report is unspecialized in the type of the examination, classify the report as associated with a non-specialist. Further, the example apparatus includes a presentation module to present a document consumer with an indication of the classification of the report.

### BRIEF DESCRIPTION OF THE DRAWINGS

FIG. 1 is a block diagram of an example medical information system.

FIG. 2 is a block diagram of an example apparatus that may be used to implement the example report classifier of FIG. 1.

FIG. 3 is a flow diagram representative of example machine readable instructions that may be executed to implement the example report classifier of FIGS. 1 and/or 2.

FIG. 4 is a block diagram of an example processor system that may be used to execute the machine readable instructions of FIG. 3 to implement the example report classifier of FIGS. 1 and/or 2.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Typically, information systems include documents or reports that are reviewed and/or generated by persons of varying levels of expertise in one or more areas related to the respective reports. In many systems and/or industries having a plurality of aspects, subject areas, and/or fields, some reviewers and/or authors may have greater expertise in a first area than a second area. However, such authors are still often required to review and/or generate reports related to the second area. As a result, these information systems include reports related to the first area reviewed and/or generated by experts or specialists in the first area, as well as reports related to the first area reviewed and/or generated by non-experts or non-specialists in the first area (yet still capable and competent).

In high volume information systems in which consumers or users of reports are required to analyze a large number of reports, even for a single matter or instance (e.g., a healthcare episode), the reviewers may place a greater importance on reports generated or reviewed by one of high expertise (e.g., a specialist) in a area or subject matter related to the report.

The example methods, apparatus, systems, and/or articles of manufacture described herein can be used to classify one or more reports stored in connection with an information system, such as clinical reports in a healthcare information system. In particular, the example methods, apparatus, systems, and/or articles of manufacture described herein are capable of determining a level of knowledge, skill, and/or experience (sometimes referred to herein collectively as expertise) associated with a reviewer or author of a report in a particular area related to subject matter of the report. In other words, the example methods, apparatus, systems, and/or articles of manufacture described herein are capable of determining whether a reviewer or author of a report is a specialist in a particular area related to subject matter of the report.

Further, the example methods, apparatus, systems, and/or articles of manufacture described herein can designate or classify the report as reviewed and/or generated by one having a certain level of expertise (e.g., a specialist) in the particular area related to the report. For example, a first report generated by a first author of a first, relatively high level of expertise in the particular area may be classified as a Specialist-Written Report. A second report generated by a second author of a second level of expertise lower than the first level of expertise in the particular area may be classified as a Non-Specialist-Written Report. A third report generated by a third author of third level of expertise higher than the first level of expertise in the particular area may be classified as a Senior-Specialist-Written Report. That is, there is no limit to the number of classifications available for classifying the reports. In cases in which the reports were reviewed, rather than generated, by reviewers of different levels of expertise, a report may be classified as a Specialist-Reviewed Report or a Non-Specialist-Reviewed Report, depending on the reviewer's level of expertise. Additional or alternative types and/or amounts of classifications may be implemented by the example methods, apparatus, systems, and/or articles of manufacture described herein. In some examples, the term ‘Non-Specialist’ may be substituted with another term, such as ‘General’ or ‘Board Certified.’

The designation of a practitioner as a specialist and/or the classification levels among specialists may be determined based on, for example, a number of years at practice in a certain area or subspecialty, a number of procedures or cases completed in a certain area or subspecialty, evaluation (s) of a board, panel and/or other body of peers, completion of a fellowship in a certain area or subspecialty, board certification, and/or any other suitable bases. For example, a general radiologist who has completed a relatively high number of certain advanced procedures (e.g., catheter-based lower extremity angiograms) may be designated as a specialist in those advanced procedures after reaching a threshold number of the procedures. The threshold may be determined by any suitable entity, such as a hospital board or dedicated panel.

Further, the example methods, apparatus, systems, and/or articles of manufacture described herein provide a document consumer with a plurality of options for reviewing and/or analyzing a set of reports. In particular, the example methods, apparatus, systems, and/or articles of manufacture described herein enable a document consumer to, for example, sort, route, search, and/or prioritize a set of reports via one or more user interface options. For example, when a document consumer, such as a healthcare practitioner, is reviewing a medical history having multiple reports related to one or more conditions or episodes, the examples described herein enable the practitioner to organize a presentation of the reports according to a level of expertise associated with the respective author of each report. In some examples, sorting, routing, and/or prioritizing of the reports according to the classifications described herein may be automatic instead of in response to a user input or instructions. Additional or alternative presentation options provided by the examples described herein are described in greater detail below.

While the example methods, apparatus, systems, and/or articles of manufacture described herein are described in conjunction with a healthcare information system, the example methods, apparatus, systems, and/or articles of manufacture described herein may be implemented in association with any suitable type of information system involving report reviewers or authors having different levels of expertise in different areas of interest or application. For example, a civil engineering organization may include a plurality of civil engineers having different levels of expertise in using different materials for a structure. A first civil engineer may be a specialist in concrete structural design and a second civil engineer may be a specialist in steel structural design. Using the example methods, apparatus, systems, and/or articles of manufacture described herein, engineering specifications and/or reports involving a concrete structure that were reviewed and/or generated by the first civil engineer can be classified as Specialist-Reviewed or Specialist-Generated Reports. On the other hand, engineering specifications and/or reports involving a steel structure that were reviewed and/or generated by the first civil engineer can be classified as Non-Specialist-Reviewed or Non-Specialist-Generated Reports. Engineering specifications and/or reports reviewed and/or generated by the second civil engineer may be classified in a similar manner. Any other system having similar aspects can utilize the example methods, apparatus, systems, and/or articles of manufacture described herein.

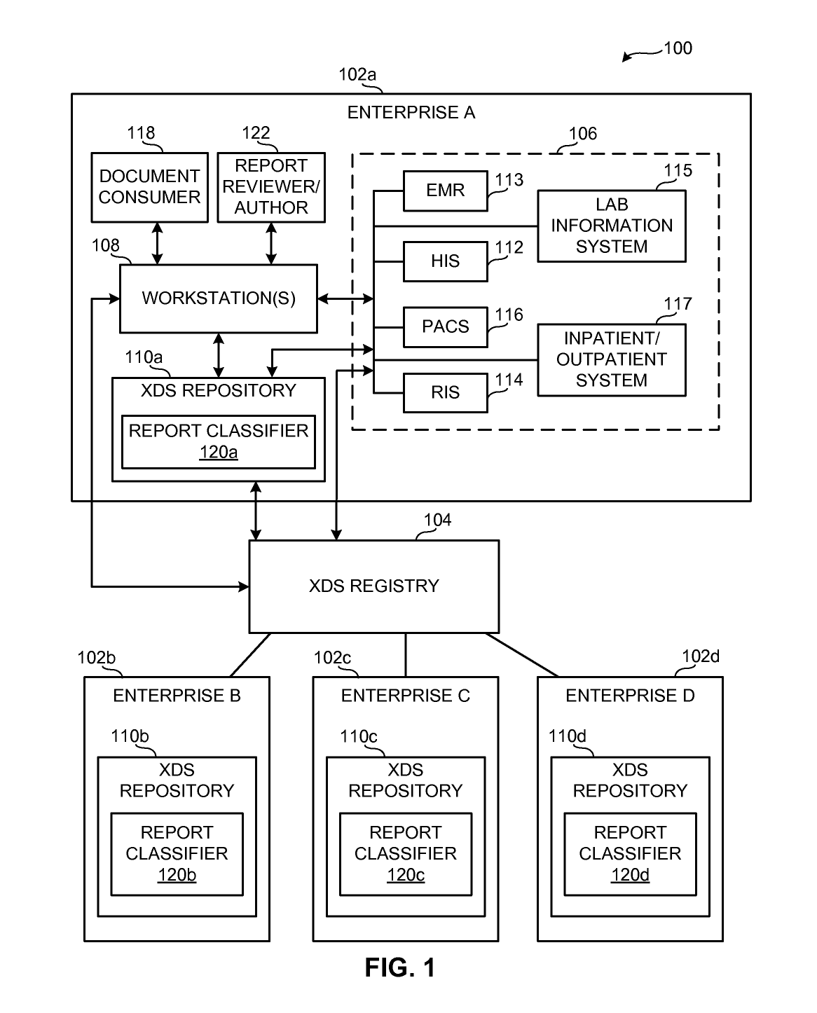

FIG. 1 is a block diagram of an example healthcare data system 100 capable of implementing the example methods, apparatus, systems, and/or articles of manufacture described herein to classify reports according to a expertise level of the reviewers and/or authors of the reports. The example healthcare data system 100 of FIG. 1 includes a plurality of healthcare enterprises 102a-d that are members of an affinity domain. In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown in FIG. 1 for purposes of brevity and not limitation.

The example healthcare data system 100 of FIG. 1 implements an Integrated the Healthcare Enterprise (IHE) Cross-Enterprise Document Sharing (XDS) integration profile to facilitate the sharing (e.g., registration, distribution, access, etc.) of healthcare data among the healthcare enterprises 102a-d (referred to as an Affinity Domain in IHE XDS terminology) via a common registry 104. The XDS profile includes a common set of standards or policies for the healthcare enterprises 102a-d, which agree to share medical data using a common infrastructure. While the example healthcare data system 100 of FIG. 1 is shown as implemented by a XDS integration profile, any additional or alternative medical data sharing system (e.g., any health information exchanges (HIEs) and/or regional health information organizations (RHIOs) designed to enable a plurality of healthcare enterprises to exchange healthcare information) can be used to implement the example methods, apparatus, systems, and/or articles of manufacture described herein. Moreover, the example methods, apparatus, systems, and/or articles of manufacture described herein may be implemented on a healthcare data system 100 without information sharing capabilities, such as a standalone physician office, clinic, or hospital having a central data system.

The example hospital 102a includes a healthcare information system 106, one or more workstations 108, and a repository 110a. The healthcare information system 106 includes one or more of a hospital information system (HIS) 112, an electronic medical record system (EMR) 113, a radiology information system (RIS) 114, a lab information system 115, a picture archiving and communication system (PACS) 116, and an inpatient/outpatient system 117. In the illustrated example, the hospital information system 112, the electronic medical record system 113, the radiology information system 114, the lab information system 115, the PACS 116, and the inpatient/outpatient system 117 are housed in the hospital 102a and locally archived. However, in other implementations, one or more elements of the example healthcare information system 106 may be housed one or more other suitable locations. Furthermore, one or more components of the healthcare information system 106 may be combined and/or implemented together. For example, the radiology information system 114 and/or the PACS 116 may be integrated with the hospital information system 112; the PACS 116 may be integrated with the radiology information system 114; and/or the six example information systems 112, 113, 114, 115, 116, and/or 117 may be integrated together. Preferably, information (e.g., test results, observations, diagnosis, discharges, admissions, findings, reports, etc.) is entered into the elements of the example healthcare information system 106 by healthcare practitioners (e.g., radiologists, physicians, technicians, administrators, etc.) before, after, and/or during a patient examination and/or testing session. In some examples, the equipment (e.g., an MRI machine) of these systems (e.g., the PACS 116) stores the information (e.g., an MRI scanned image) automatically upon acquiring the information.

The hospital information system 112 stores healthcare information such as clinical reports, patient information, practitioner information, and/or financial data received from, for example, personnel at a hospital, clinic, and/or a physician's office. The EMR system 113 stores information related to patients and/or practitioners, medical histories, current treatment records, etc. The radiology information system 114 stores information such as, for example, radiology reports, x-ray images, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film).

The lab information system 115 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116. The inpatient/outpatient system 117 stores information related to the admission and discharge of patients such as follow up schedules, patient instructions provided by a practitioner, prescription information, presenting symptoms, contact information, etc.

While example types of information are described above as being stored in certain elements of the healthcare information system 106, different types of healthcare data may be stored in one or more of the hospital information system 112, the EMR system 113, the radiology information system 114, the lab information system 115, the PACS 116, and/or the inpatient/outpatient system 117. Further, the information stored in these elements may overlap and/or share types of data.

The hospital information system 112, the EMR system 113, the radiology information system 114, the lab information system 115, the PACS 116, and/or the inpatient/outpatient system 117 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a virtual private network, a wired or wireless Local Area Network, and/or a wired or wireless Wide Area Network. In some examples, the healthcare information system 106 also includes a broker (e.g., a Mitra Imaging's PACS Broker) to allow medical information and medical images to be transmitted together and stored together.

In some examples, information stored in one or more components of the healthcare information system 106 is formatted according to the HL7 clinical communication protocol, the Digital Imaging and Communications in Medicine (DICOM) protocol, and/or any other suitable standard and/or protocol. The equipment used to obtain, generate, and/or store the information of the healthcare information system 106 may operate in accordance with the HL7 clinical communication protocol, the DICOM protocol, and/or any other suitable standard and/or protocol.

The repository 110a, which is shown as an XDS repository in the example of FIG. 1, facilitates the sharing of healthcare documents generated by the healthcare information system 106 with other enterprises (e.g., enterprises 102b-d). In particular, the repository 110a receives images, medical reports, administrative information, financial data, insurance information, and/or other healthcare information from the healthcare information system 106 and stores such information in, for example, a database or any suitable data structure. Thus, to use XDS terminology, the medical information 106 is a document source that provides the repository 110a clinical data to be shared among the enterprises 102a-d. As shown in the example of FIG. 1, each of the enterprises 102b-d includes an XDS repository 110b-d that functions in a similar manner as the repository 110a of the hospital 102a. Thus, the XDS repositories 110a-d collectively store healthcare documents and the content thereof that are capable of being shared across the affinity domain of the example healthcare data system 100 of FIG. 1.

Further, the repository 110a receives metadata associated with the images, medical reports, administrative information, financial data, insurance information, and/or other healthcare information from the healthcare information system 106 and forwards the metadata to the registry 104, which stores the metadata in a database and/or any other suitable storage mechanism. The metadata is used by the registry 104 to index the healthcare information stored at the repository 110a (along with the information stored at the repositories of the other enterprises 102b-d). The metadata corresponds to one of more types of identifying information (e.g., identification numbers, patient names, record numbers, social security numbers, payment status indicators, or any other identifying) associated with, for example, medical reports stored at the repositories 110a-d. The registry 104 is capable of receiving queries into the contents of the repositories 110a-d of the healthcare data system 100 and using the indexed metadata to satisfy the queries.

In the illustrated example, the registry 104 receives such queries from a document consumer 118. The document consumer 118 may be associated with one or more of the enterprises 120a-d and/or may have access to the registry 104 via alternative(s) associations. For example, the document consumers 118 may be a researcher that was granted access to the contents of the repositories 110a-d of the affinity domain defined by the example healthcare data system 100. In some examples, the document consumer 118 is a referring physician, a patient, a reviewing practitioner (e.g., a first radiologist reading the document generating by a second radiologist), or any other person or entity interested in the healthcare documents described herein. In the example of FIG. 1, the document consumer 118 uses a first one of the workstation(s) 108 to query the registry 104. The workstation(s) 108 may access the registry 104 via the repository 110a or directly, as illustrated in FIG. 1. Additionally or alternatively, the document consumer 118 may directly query the healthcare information system 106 via, for example, one of the workstation(s) 108.

The workstation(s) 108 may be any equipment (e.g., a personal computer) capable of executing software that permits electronic data (e.g., medical reports) and/or electronic medical images (e.g., x-rays, ultrasounds, MRI scans, clinical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc. The workstation(s) include and/or are coupled to one or more presentation devices (e.g., a standard computer monitor, speakers, touch-screen devices, specialized monitors to view specific images such as x-rays, magnetic resonance imaging (MRI) scans, printers, etc.) capable of presenting images, video, audio, text, etc. to one or more practitioners, such as the document consumer 118.

Multiple workstations 108 can communicate with each other, the healthcare information system 106, and/or the XDS repository 110a and registry 104 to obtain shared medical information and convey the same to the user of the workstation(s) 108. Further, the workstation(s) 108 are capable of implementing a user interface to enable a healthcare practitioner to interact with the healthcare data system 100 and/or the registry 104 and the components thereof. In the illustrated example, the user interface enables a search of one or more components or elements of the healthcare data system 100 and/or one or more external databases containing relevant healthcare information. The document consumer 118 can use such an interface to query medical resources using different criteria such as, for example, a patient name, a patient identification number, a social security number, date(s) of treatment(s), type(s) of treatment, etc.

To implement the example methods, apparatus, systems, and/or articles of manufacture described herein, the repository 110a of the healthcare data system 100 of FIG. 1 includes an example report classifier 120a. Similarly, the repositories 110b-d of the other healthcare enterprises 102b-d each include a report classifier 120b-d that operates in a substantially similar manner as the report classifier 120a of the first repository 110a. The example report classifier 120a can be implemented in additional or alternative elements and/or locations in the example healthcare data system 100 of FIG. 1 and/or any other type of medical data system. For example, the report classifier 120a may be implemented in one or more of the workstation(s) 108 and/or one or more elements of the healthcare information system 106 (e.g., the hospital information system 112, the electronic medical record system 113, the radiology information system 114, the lab information system 115, the PACS 116, and/or the inpatient/outpatient system 117). When implemented in a standalone enterprise (e.g., a healthcare information system not involving sharing of healthcare data between healthcare enterprises), the example report classifier 120a may be implemented by or in association with, for example, a central server and/or storage device with which a plurality of intra-enterprise devices communicate.

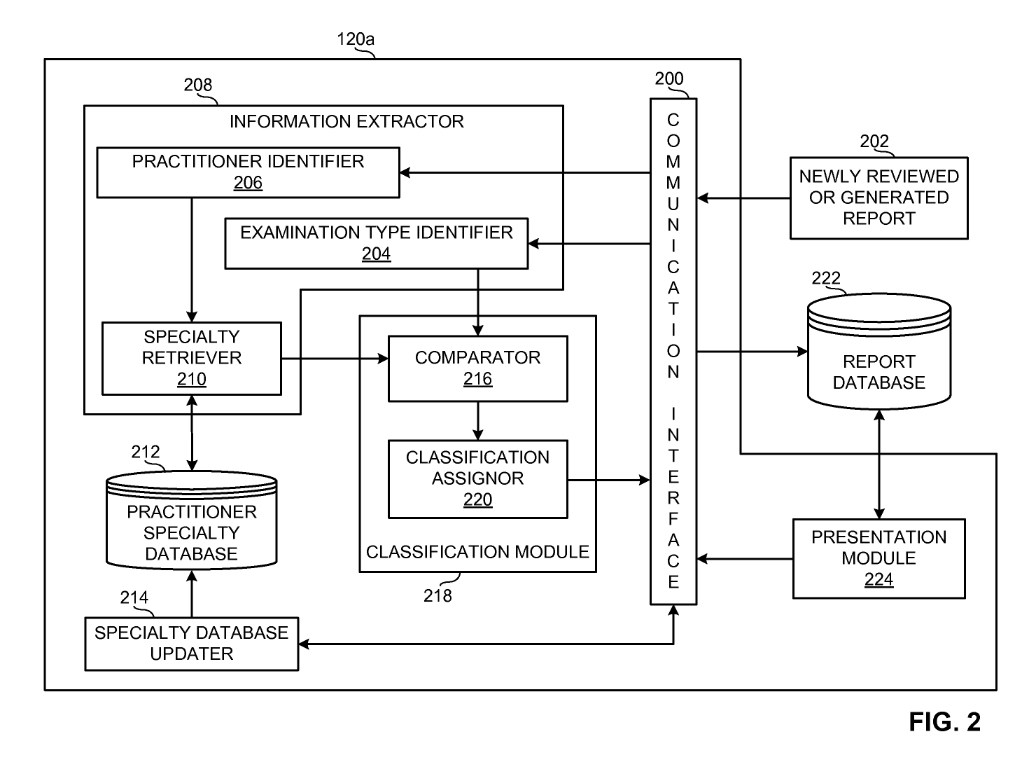

As described in greater below in connection with FIG. 2, the example report classifier 120a of FIG. 1 provides, for example, classifications for clinical reports that inform the document consumer 118 of a level of expertise associated with reviewers and/or authors 122 of the clinical reports. The example reviewer/author 122 of FIG. 1 may be a practitioner evaluating or generating a report using one or more components of the example healthcare data system 106 of FIG. 1. For example, the reviewer/author 122 of FIG. 1 may be a radiologist reviewing examination results from the RIS 114 and/or generating a report therefrom to be stored in the EMR 113. The example report classifier 120a provides additional or alternative features, benefits, and/or improvements as described herein.

FIG. 2 is a block diagram of an example apparatus that may be used to implement the example report classifier 120a of FIG. 1. In the illustrated example of FIG. 2, the example report classifier 120a includes a communication interface 200. The example communication interface 200 conveys and receives data, instructions, and/or any other suitable information to and from one or more of the elements of the healthcare data system 100, such as the workstation(s) 108 being used by the document consumer 118 and/or the reviewer/author 122. In the illustrated example of FIG. 2, the communication interface 200 receives a report 202 reviewed and/or generated by the reviewer/author 122 designated for storage in the repository 110a and/or indexing in the registry 104. In some examples, the communication interface 200 is capable of detecting when a new report is received by, for example, the repository 110a, a component of the healthcare data system 106, and/or one or more of the workstation(s) 108. Additionally or alternatively, devices such as the repository 110a, a component of the healthcare data system 106, and/or one or more of the workstation(s) 108 may be configured to route a newly reviewed and/or generated report to the example report classifier 120a. The newly reviewed and/or generated report 202 (sometimes referred to herein as the new report 202) may be, for example, a report written or reviewed by a radiologist regarding an x-ray image of an anatomical structure, such as a spine. As described below, the new report 202 may be a different type of report reviewed or generated by a different type of practitioner regarding a different type of image. That is, the example methods and apparatus described herein can apply to any suitable type of report related to any suitable imaging modality such as, for example, x-ray, computed tomography, ultrasound, magnetic resonance imaging, etc.

In the illustrated example of FIG. 2, the communication interface 200 conveys the new report 202 to an examination type identifier 204 and a practitioner identifier 206 of an information extractor 208. The example examination type identifier 204 of FIG. 2 is capable of analyzing the report 202 to determine a type of examination associated with the report 202. For example, when the report 202 is a standardized document including a plurality of standardized fields or entries, the example examination type identifier 204 automatically accesses one or more of the fields or entries having a descriptor of the corresponding examination. In other examples, the examination type identifier 204 analyzes textual portions of the report 202 to find keywords that can be used to determine what type of examination is associated with the report 202. Additionally or alternatively, in systems implementing the example report classifier 120a described herein, generating the report 202 may include entering a type of examination in the report in a designated field or portion of the report 202 (e.g., in a file label, a title, a line item, etc.). In such instances, the example examination type identifier 204 is configured to access the designated field or portion of the report 202 to determine the type of the corresponding examination.

Using any of these and/or any other suitable approaches or methods, the example examination type identifier 204 may identify the examination type according to a type of image, a type of lab result, a type of equipment used during the examination, a part of anatomy involved in the examination, and/or any other subject area. To continue the above example, the examination type identifier 204 identifies the new report 202 as (1) an x-ray (2) related to the spine. In the illustrated example of FIG. 2, the examination type identifier 204 is configured to identify one or more of a set of examination types defined therein. This set of examination types can be updated or changed by, for example, an administrator associated with the healthcare information system 100 of FIG. 1 and/or a technician associated with the example report classifier 120a. Furthermore, the set of examination types can be of any suitable level of granularity in regards to, for example, an anatomical hierarchy. For example, while a first examination type may be ‘skeletal,’ a second examination type may be ‘skeletal-wrist.’ The level of granularity can be modified or updated by altering the set of examination types used by the example examination type identifier 204 and/or the portions of the received report 202 analyzed thereby.

Referring back to the example practitioner identifier 206 of the example information extractor 208, the practitioner identifier 206 is capable of analyzing the new report 202 to obtain an identification of a person associated with the report 202. In the illustrated example, the practitioner identifier 206 is capable of obtaining an identification of the reviewer/author 122 of FIG. 1 that reviewed or generated the new report 202. When the report 202 is a standardized document including a plurality of standardized fields or entries, the example practitioner identifier 206 automatically accesses one or more of the fields or entries having an identification of the corresponding practitioner, such as the reviewer/author 122 of FIG. 1. In other examples, the practitioner identifier 206 analyzes textual portions of the report 202 to find keywords that can be used to obtain the identification corresponding to the reviewer/author 122 associated with the report 202. Additionally or alternatively, in systems implementing the example report classifier 120a described herein, generating the report 202 may include entering an identification of reviewer/author 122 associated with the report in a designated field or portion of the report 202 (e.g., in a file label, a title, a line item, etc.). In such instances, the example practitioner identifier 206 is configured to access the designated field or portion of the report 202 to identification of the corresponding reviewer/author 122.

The identification to be obtained by the example practitioner identifier 206 may be, for example, an employee number (e.g., at least a portion of a social security number), a registration number, an alphanumeric label assigned to the practitioner, and/or at least a portion of a name. The example practitioner identifier 206 conveys the obtained identification to a specialty retriever 210 of the information extractor 208. The example specialty retriever 210 accesses a practitioner specialty database 212 using the identification received from the practitioner identifier 206. In the illustrated example, the specialty retriever 210 uses the identification associated with the reviewer/author 122 in a query of the practitioner specialty database 212. The example practitioner specialty database 212 includes one or more data structures storing information related levels of expertise in a plurality of examination types associated with each of a plurality of practitioners. For example, an entry in the database 212 associated with the example reviewer/author 122 may indicate that the reviewer/author 122 has a high level of expertise in examination types including CT scans and/or CT scans involving the brain. In such an instance, the reviewer/author 122 is considered a specialist in CT scans and/or CT scans involving the human brain.

Similar to the examination types described above, the example practitioner specialty database 212 may include information of any suitable granularity. In some examples, the granularity of the practitioner specialty database 212 is substantially similar to the granularity of the examination types available to the example examination type identifier 204. Thus, a practitioner may be designated as a specialist in skeletal matters, but not as a specialist in skeletal matters involving the wrist. That is, as the level of granularity involved in the examination type increases, the level of granularity of specialties increases as well.

Also, the example practitioner specialty database 212 may include rankings in regards to a level of expertise associated with, for example, the reviewer/author 122. When the reviewer/author 122 has only recently been designated as a specialist in a certain area, the corresponding entry in the practitioner specialty database 212 may indicate that the reviewer/author 122 is a Junior Specialist. When the reviewer/author 122 has been designated as a specialist in a certain area for a first predetermined period of time (e.g., a certain number of years) or has completed a first number of procedures or cases in the area, the corresponding entry in the practitioner specialty database 212 may indicate that the reviewer/author 122 is a Specialist. When the reviewer/author 122 has been designated as a specialist in a certain area for a second predetermined period of time (e.g., a certain number of years) or has completed a second number of procedures or cases in the area, the corresponding entry in the practitioner specialty database 212 may indicate that the reviewer/author 122 is a Senior-Specialist. Additionally or alternatively, when the reviewer/author 122 completes a Fellowship in a given specialty or subspecialty (e.g., neuroradiology, musculoskeletal imaging, breast imaging, pediatric imaging, internventional radiology, etc.), the corresponding entry in the practitioner specialty database 2122 may indicate that the reviewer/author 122 is a Senior-Specialist. Additional or alternative designations and/or number of designations may be employed by the example practitioner specialty database 212.

In some examples, the reviewer/author 122 is designated as one type of specialist at first level of granularity and a second type of specialist at a second level of granularity. For example, the reviewer/author 122 may be designated as a Specialist in matters related to skeletal injuries and, at the same time, may be designated as a Junior-Specialist in matters related to wrist injuries. Such instances may results from the reviewer/author 122 focusing his or her practice to a more specific area or specializing in the same (e.g., becoming board certified in the specific area).

The example report classifier 120a includes a specialty database updater 214 to provide updates or changes to the corresponding database 212. The example updater 214 may receive (e.g., via the communication interface 200 as shown in FIG. 2) instructions from, for example, an administrator associated with the first healthcare enterprise 102a (and/or any of the other healthcare enterprises 102b-d) to update an entry of the database 212 corresponding to the reviewer/author 122 from a non-specialist entry to a specialist entry. Such an update may result from the reviewer/author 122 reaching a certain level of experience, obtaining a certification in a certain area of skill, obtaining an approval of a board of peers, and/or as a result of any other suitable event. Additionally or alternatively, the example specialty database updater 214 may modify an entry to alter the level of specialty of, for example, the reviewer/author 122. That is, the example specialty database updater 214 may change a Specialist to a Senior-Specialist.

In response to the query received from the specialty retriever 210 including the identification obtained by the practitioner identifier 206, the practitioner specialty database 212 returns one or more examination types for which the corresponding practitioner is considered a specialist. These examination types are sometimes referred to herein as specialty types. To continue the above example, the reviewer/author 122 is specialist in (1) CT scans (2) involving the brain. The example specialty retriever 210 conveys the one or more specialty types to a comparator 216 of a classification module 218. Further, the examination type identifier 204 conveys the examination type(s) of the new report 202 obtained thereby to the example comparator 216. As described above, the new report 202 is an x-ray of a spine in the illustrated example of FIG. 2

The example comparator 216 compares the examination type(s) received from the examination type identifier 204 to the specialist types received from the specialty retriever 210. The comparison may be performed at a level of granularity substantially similar to the level of granularity associated with the identified examination type(s) and/or the obtained specialty type(s). This comparison informs the report classifier 120a as to whether the reviewer/author 122 is specialized in the examination type(s) related to the new report 202. For example, if the examination type(s) received from the examination type identifier 204 match at least one of the specialist types received from the specialty retriever 210, the comparator 216 generates an indication that the report 202 was reviewed and/or authored (depending on the role played by the reviewer/author 122) by a specialist. Conversely, if the examination type(s) received from the examination type identifier 204 do not match any of the specialist types received from the specialty retriever 210, the comparator 216 generates an indication that the report 202 was reviewed and/or authored (depending on the role played by the reviewer/author 122) by a non-specialist. Additionally, the example comparator 216 conveys information related to which of the examination type(s) match the specialt(ies) of the reviewer/author 122. In the illustrated example, in which the reviewer/author of the report is a specialist in CT scans of the brain and the new report 202 is an x-ray of a spine, neither the anatomical structure of the report 202 nor the type of image associated with the report 202 matches a specialty of the reviewer/author 122. However, if the reviewer/author 122 would have been deemed a specialist in either x-ray analysis or spines, the example comparator 216 would have determined that the new report 202 was, for example, Specialist Reviewed or Specialist Authored, depending on the role played by the reviewer/author 122 in relation to the report 202. In some examples, the comparator 216 may require both the anatomical structure of the report 202 and the type of image associated with the report 202 to match for the report 202 to be considered Specialist Reviewed or Specialist Authored. Other aspects in addition to anatomical structure and image-type may be used by the example report classifier 120a.

The example comparator 216 conveys this indication to a classification assignor 220 of the classification module 218. In the illustrated example, the classification assignor 220 translates the results received from the comparator 216 to an instruction to add or modify a classification field associated with the report 202. In the example of FIG. 2, the example classification assignor 220 conveys the instruction to the communication interface 200, which forwards the instruction to a report database 222. In some examples the classification assignor 220 may convey the instruction directly to the report database 222 and/or any other device or component designated to store the new report 202. In the event that the comparator 216 found a match between one or more examination types and one or more specialty types for the report 202, the example classification assignor 220 also conveys information related to such a match(es) to the report database 222. Thus, the example report database 222 includes data regarding the report 202 was reviewed/authored by a specialist and data regarding in which area of the report 202 the reviewer/author 122 is specialized and at what level granularity the match occurred.

The example report database 222 is capable of interpreting the instruction received from the classification assignor 220 and using the same to add or update the corresponding classification associated with the report 202 in the report database 222. In the illustrated example, the report database 222 is part of the XDS repository 110a and, thus, is part of the XDS affinity domain shown in FIG. 1. Accordingly, the report 202 and the classification thereof can be indexed at the example registry 104 and/or shared across the healthcare enterprises 102a-d of the example system 100 of FIG. 1. Additionally or alternatively, the report database 222 may be stored in any other suitable location, such as in one or more components of the healthcare information system 106 and/or in other repositories 110b-d of other healthcare enterprises 102b-d.

As a result of the operations of the report classifier 120a on the new report 202, the report database 222 includes an entry corresponding to the new report 202 that indicates whether the report 202 was reviewed and/or generated by a specialist or non-specialist in an area related to the report 202. Other reports in the database 222 include similar information and, in some instances, are related to a similar healthcare episode for the same patient. That is, the example report database 222 includes medical histories having multiple reports for patients. To convey this information to, for example, the example document consumer 118 of FIG. 2, the example report classifier 120a of FIG. 2 includes a presentation module 224. The example presentation module 224 may be called by, for example, the document consumer 118 via one of the workstation(s) 108 of FIG. 1. In such instances, the document consumer 118 may be reviewing a medical history related to a first patient by using the workstation(s) 108 to access one or more reports in the healthcare information system 106.

The presentation module 224 enables the document consumer 118 to view and/or search the reports of the report database 222 in one or more manners according to the classifications associated with the reports. For example, the presentation module 224 enables the document consumer 118 to sort reports associated with a particular healthcare episode, body part, condition, and/or symptom by the classification described herein. As a result, a set of reports related to, for example, a stroke or a patient's heart are presented to the document consumer 118 in an organization (e.g., an order) dictated by the classification associated with the reports. For example, a first report related to a first magnetic resonance imaging (MRI) test involving a patient's heart of a medical history may be classified as authored by a specialist (e.g., in reading MRIs or in cardiology). A second report related to a second MRI involving the heart test may be classified as authored by a non-specialist (e.g., a primary physician). A third report related to an electrocardiography (EKG) involving the heart may be classified as reviewed by a specialist (e.g., a cardiologist or an emergency room physician deemed by a panel of his or her peers to qualify as a specialist in reading EKG tests).

The example presentation module 224 may be configured, in response to a selection of such an option on a user interface of the workstation(s) 108 or automatically according to one or more settings, to present the first and third reports at the beginning of the medical history with a designation of the ‘Specialist’ classification prominently displayed thereon. The second, ‘Non-Specialist’ report may be displayed in a later portion of the medical history with a designation of the ‘Non-Specialist’ classification prominently displayed thereon. Further, reports reviewed/authored by higher level specialists (e.g., Senior-Specialists) may be prioritized higher than reports reviewed/authored by other specialists (e.g., Junior-Specialists). In other words, the example presentation module 224 may prioritize the reports of a medical history for the document consumer 118 according to the classifications described herein.

Moreover, the example presentation module 224 is capable of enabling the document consumer 118 to sort and resort the reports of a medical history and/or a collection of clinical reports (e.g., for purposes of a study and/or research). The document consumer 118 may be interested only in reports generated by a specialist. In such instances, the document consumer 118 can utilize the example presentation module 224 to exclude ‘Non-Specialist’ authored reports.

In some examples, the presentation module 224 may also provide the document consumer 118 an opportunity to modify the current classification associated with a report stored in the database 222. In such instances, the example presentation module 224 may require authorization from the document consumer 118 to determine whether the document consumer 118 is qualified and/or designated to make such a modification. In some examples, the document consumer 118 may place a request for the modification via the presentation module 224 to be submitted to a panel, for example.

Depending on the classification, the document consumer 118 may place higher or lower degree of confidence in the report 202 relative to, for example, other reports in the medical history having a different classification. This results in an increased efficiency when reviewing clinical documents as the document consumer 118 can spend less time re-reviewing test results already reviewed by a specialist. Furthermore, the document consumer 118 may be less confident in a report reviewed and/or authored by a non-specialist and, thus, readily prepared to re-review the report and re-run the corresponding examination if the document consumer 118 feels such a step is necessary.

While an example manner of implementing the report classifier 120a of FIG. 1 has been illustrated in FIG. 2, one or more of the elements, processes and/or devices illustrated in FIG. 2 may be combined, divided, re-arranged, omitted, eliminated and/or implemented in any other way. Further, the example communication interface 200, the example information extractor 208 including the example examination type identifier 204, the example practitioner identifier 206 and the example specialty retriever 210, the example practitioner specialty database 212, the example specialty database updater 214, the example classification module 218 including the example comparator 216 and the example classification assignor 220, and/or, more generally, the example report classifier 120a of FIG. 2 may be implemented by hardware, software, firmware and/or any combination of hardware, software and/or firmware. Thus, for example, any of the example communication interface 200, the example information extractor 208 including the example examination type identifier 204, the example practitioner identifier 206 and the example specialty retriever 210, the example practitioner specialty database 212, the example specialty database updater 214, the example classification module 218 including the example comparator 216 and the example classification assignor 220, and/or, more generally, the example report classifier 120a of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example communication interface 200, the example information extractor 208 including the example examination type identifier 204, the example practitioner identifier 206 and the example specialty retriever 210, the example practitioner specialty database 212, the example specialty database updater 214, the example classification module 218 including the example comparator 216 and the example classification assignor 220, and/or, more generally, the example report classifier 120a of FIG. 2 are hereby expressly defined to include a tangible medium such as a memory, DVD, CD, etc., storing the software and/or firmware. Further still, the example report classifier 120a of FIG. 2 may include one or more elements, processes and/or devices in addition to, or instead of, those illustrated in FIG. 2, and/or may include more than one of any or all of the illustrated elements, processes and devices.

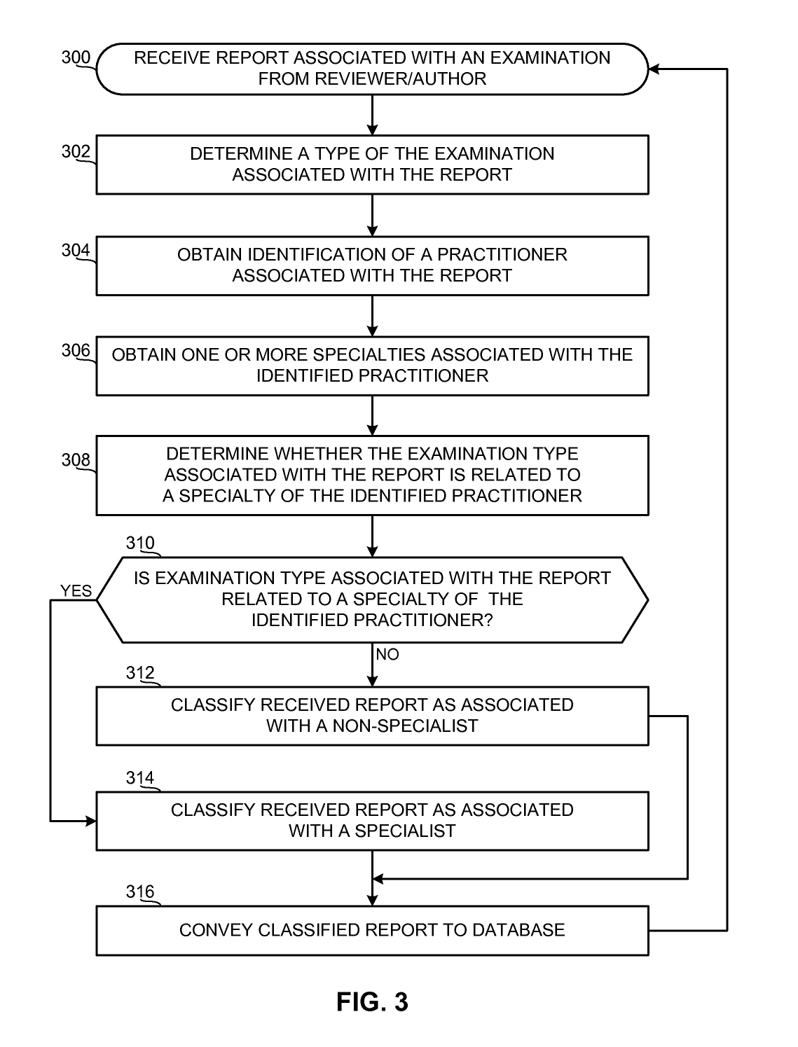

FIG. 3 is a flow diagram representative of example machine readable instructions that may be executed to implement the example report classifier 120a of FIGS. 1 and/or 2 to classify reports. The example processes of FIG. 3 may be performed using a processor, a controller and/or any other suitable processing device. For example, the example processes of FIG. 3 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagrams of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

In the illustrated example of FIG. 3, a newly reviewed and/or authored report, such as the report 202 of FIG. 2, is received by the example report classifier 120a of FIGS. 1 and/or 2 (block 300). The example report classifier 120a is configured to determine whether the report 202 was reviewed and/or authored by a specialist or a non-specialist in an area related to the report 202 and to provide the document consumer 118 (FIG. 2) with indication of the same. The example communication interface 200 (FIG. 2) conveys the report 202 to the example information extractor 208, which is configured to extract specific information to be utilized in the determination of whether the report 202 was reviewed and/or authored by a specialist or a non-specialist in an area related to the report 202. In particular, the report 202 is conveyed to the example examination type identifier 204 (FIG. 2) and the example practitioner identifier 206 (FIG. 2).

As described above in connection with FIG. 2, the example examination type identifier 204 determines a type of the examination associated with the report 202 (block 302). In some examples, the report 202 is associated with a plurality of examination types and, in such instances, the example examination type identifier 204 is capable of identifying each of the examination types associated with the report 202.

As described above in connection with FIG. 2, the example practitioner identifier 206 obtains an identification of a practitioner associated with the report 202 (block 304). In the illustrated example, the practitioner associated with the report 202 is the example reviewer/author 122 of FIG. 1. In some examples, the report 202 is associated with a plurality of reviewers/authors and, in such instances, the example practitioner identifier 206 is capable of obtaining an identification of each of the reviewers/authors associated with the report 202.

Upon receiving the identification of the practitioner from the practitioner identifier 206, the example specialty retriever 210 (FIG. 210) obtains one or more specialties associated with the identified practitioner (block 306). As described above in connection with FIG. 2, the example specialty retriever 210 uses the identification to query the practitioner specialty database 212, which includes a list of specialties (if any) associated with each of a plurality of practitioners. The example practitioner specialty 212 can be updated by the specialty database updater 214 (FIG. 2).

The examination type associated with the report 202 and the specialty types associated with the reviewer/author 122 are received by the example comparator 216 (FIG. 2). In the illustrated example, the comparator 216 is configured to determine whether the examination type associated with the report 202 is related to a specialty associated with the reviewer/author 122 (block 308). In particular, the example comparator 216 compares the examination type associated with the report 202 received from the examination type identifier 204 with the specialty types associated with the reviewer/author 122 received from the specialty retriever 210.

When the examination type associated with the report 202 does not match any of the specialty types associated with the reviewer/author 122 (block 310), the example classification assignor 220 (FIG. 2) classifies the report 202 as reviewed and/or generated by a non-specialist (block 312). When the examination type associated with the report 202 does not match any of the specialty types associated with the reviewer/author 122 (block 310), the example classification assignor 220 classifies the report 202 as reviewed and/or generated by a specialist (block 314). The example classification assignor 220 then conveys the classified report 202 to the report database 222 (FIG. 2) via the communication interface 200 (block 316).

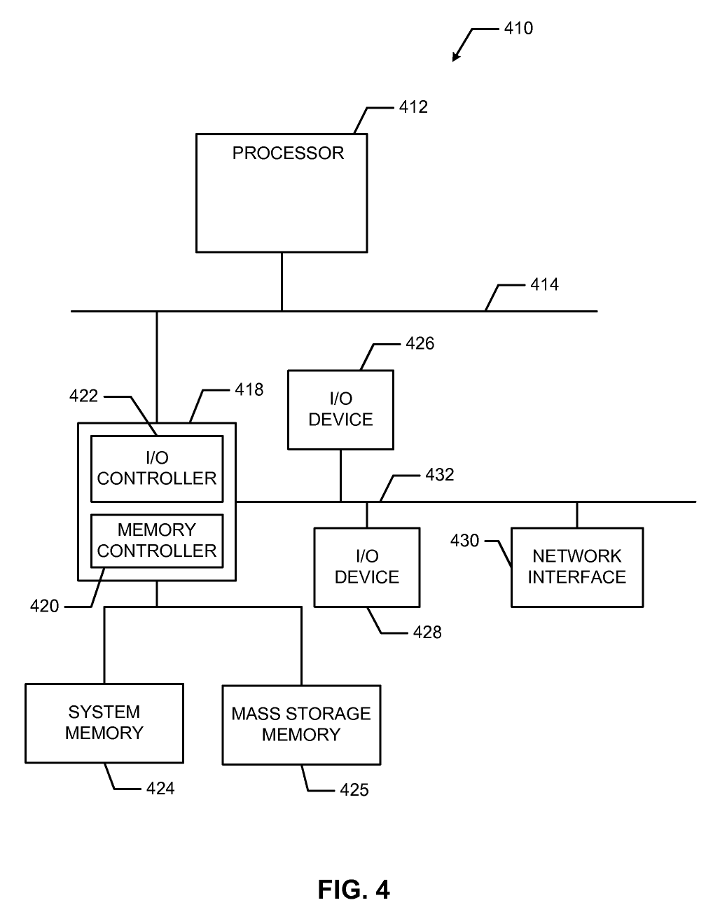

FIG. 4 is a block diagram of an example processor system 410 that may be used to implement the apparatus and methods described herein. As shown in FIG. 4, the processor system 410 includes a processor 412 that is coupled to an interconnection bus 414. The processor 412 may be any suitable processor, processing unit or microprocessor. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (I/O) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (SRAM), dynamic random access memory (DRAM), flash memory, read-only memory (ROM), etc. The mass storage memory 425 may include any desired type of mass storage device including hard disk drives, optical drives, tape storage devices, etc.

The I/O controller 422 performs functions that enable the processor 412 to communicate with peripheral input/output (I/O) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (ATM) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method to classify a report, comprising:
determining a type of an examination associated with a report;
obtaining an identification of a person associated with the report;
using the identification to determine whether the person associated with the report is specialized in the type of the examination;
when the person associated with the report is specialized in the type of the examination, classifying the report as associated with a specialist;
when the person associated with the report is unspecialized in the type of the examination, classifying the report as associated with a non-specialist; and
presenting a document consumer with an indication of the classification of the report.

2. A method as defined in claim 1, wherein the person associated with the report is an author of the report, and wherein classifying the report comprises classifying the report as authored by a specialist or non-specialist.

3. A method as defined in claim 1, wherein the person associated with the report is a reviewer of results from the examination, and wherein classifying the report comprises classifying the report as reviewed by a specialist or non-specialist.

4. A method as defined in claim 1, further comprising enabling the document consumer to prioritize a display of one or more classified reports according to a classification of the one or more reports.

5. A method as defined in claim 1, further comprising conveying the classified report to a database providing shared access to a plurality of entities.

6. A method as defined in claim 5, wherein the database is a component of an Integrating the Healthcare Enterprise (IHE) Cross-Enterprise Document Sharing (XDS) system.

7. A method as defined in claim 1, wherein the examination comprises a healthcare procedure and the report comprises a standardized healthcare document.

8. A tangible machine readable medium having instructions stored thereon that, when executed, cause a machine to:
determine a type of an examination associated with a report;
obtain an identification of a person associated with the report;
use the identification to determine whether the person associated with the report is specialized in the type of the examination;
when the person associated with the report is specialized in the type of the examination, classify the report as associated with a specialist;
when the person associated with the report is unspecialized in the type of the examination, classify the report as associated with a non-specialist; and
present a document consumer with an indication of the classification of the report.

9. A tangible machine readable medium as defined in claim 8, wherein the person associated with the report is an author of the report, and wherein classifying the report comprises classifying the report as authored by a specialist or non-specialist.

10. A tangible machine readable medium as defined in claim 8, wherein the person associated with the report is a reviewer of results from the examination, and wherein classifying the report comprises classifying the report as reviewed by a specialist or non-specialist.

11. A tangible machine readable medium as defined in claim 8 having instructions stored thereon that, when executed, cause a machine to enable the document consumer to prioritize a display of one or more classified reports according to a classification of the one or more reports.

12. A tangible machine readable medium as defined in claim 8 having instructions stored thereon that, when executed, cause a machine to convey the classified report to a database providing shared access to a plurality of entities.

13. A tangible machine readable medium as defined in claim 12, wherein the database is a component of an Integrated the Healthcare Enterprise (IHE) Cross-Enterprise Document Sharing (XDS) system.

14. A tangible machine readable medium as defined in claim 8, wherein the examination comprises a healthcare procedure and the report comprises a standardized healthcare document.

15. An apparatus to classify a report, comprising:
an examination type identifier to determine a type of an examination associated with a report;
a person identifier to obtain an identification of a person associated with the report;
a specialty retriever to obtain one or more specialties associated with the person using the identification;
a comparator to determine whether the person associated with the report is specialized in the type of the examination;
a classification assignor to:
when the person associated with the report is specialized in the type of the examination, classify the report as associated with a specialist; and
when the person associated with the report is unspecialized in the type of the examination, classify the report as associated with a non-specialist, and
a presentation module to present a document consumer with an indication of the classification of the report.

16. An apparatus as defined in claim 15, wherein the person associated with the report is an author of the report, and wherein classifying the report comprises classifying the report as authored by a specialist or non-specialist.

17. An apparatus as defined in claim 15, wherein the person associated with the report is a reviewer of results from the examination, and wherein classifying the report comprises classifying the report as reviewed by a specialist or non-specialist.

18. An apparatus as defined in claim 15, further comprising a communication interface to convey the classified report to a database providing shared access to a plurality of entities.

19. An apparatus as defined in claim 15, wherein the database is a component of an Integrated the Healthcare Enterprise (IHE) Cross-Enterprise Document Sharing (XDS) system.

20. An apparatus as defined in claim 19, wherein the examination comprises a healthcare procedure and the report comprises a standardized healthcare document.
